(19) United States
(12) Patent Application Publication
(10) Pub. No.: US 2019/0351624 A1
(43) Pub. Date: Nov. 21, 2019

(54) SYSTEMS AND PROCESSES FOR REPAIRING FIBER-REINFORCED POLYMER STRUCTURES

(71) Applicant: GM GLOBAL TECHNOLOGY OPERATIONS LLC, Detroit, MI (US)

(72) Inventors: Xiaosong Huang, Novi, MI (US); Hamid G. Kia, Bloomfield Hills, MI (US)

(73) Assignee: GM GLOBAL TECHNOLOGY OPERATIONS LLC, Detroit, MI (US)

(21) Appl. No.: 15/981,470

(22) Filed: May 16, 2018

(51) Int. Cl. B29C 65/30; B32B 1/00; B32B 7/12; B32B 25/20; B32B 27/28; B29C 65/20; B29C 65/00; B29C 73/12; H05B 3/34

(52) U.S. Cl. CPC B29C 65/30; B32B 1/00; B32B 7/12; B32B 25/20; B32B 27/281; B29L 2031/3005; B29C 66/472; B29C 66/721; B29C 73/12; H05B 3/34; B29C 65/20

(57) ABSTRACT

Presented are repair systems for fixing filler-reinforced polymer structures, methods for making/using such repair systems, and techniques for repairing surface damage/defects of multidimensional fiber-reinforced polymer (FRP) panels. A repair system for fixing a contoured surface of an FRP structure includes a flexible contact sheet that is fabricated from a thermally stable polymer, and has a textured contact surface that seats on the FRP structure and overlays the damaged area. A rigid cover sheet, which may be fabricated from a metal material, a polymeric material, and/or resin-impregnated fiber, has a complementary surface that conforms to the contoured surface of the FRP structure and covers the flexible contact sheet. The repair system also includes a heating element that lays against the rigid cover sheet and applies heat to the contoured surface with a substantially uniform profile that is sufficient to soften/melt portions of the FRP structure neighboring the damaged area.

### INTRODUCTION

The present disclosure relates generally to fiber-reinforced polymer structures. More specifically, aspects of this disclosure relate to systems, devices and processes for repairing multidimensional thermoplastic or thermoset polymer composite panels.

Composite materials are used for manufacturing a vast array of modern products. Many current-production automobiles, watercraft, and aircraft, for example, are assembled with load-bearing body panels, aesthetic trim panels, support frame members, as well as various other components that are manufactured, in whole or in part, from composite materials. Fiber-reinforced plastic (FRP) is an example composite material that is used in mass-production manufacturing applications, favored for its high strength-to-weight ratio, increased elasticity, corrosion resistance, and light weight properties. FRP's are typically formed by suspending a high-tensile-strength fibrous material, such as glass, carbon, aramid, or basalt fibers, within a solidified polymer, such as a thermoset epoxy-resin matrix or a thermoplastic polyester or nylon.

As with any product, FRP components are subject to damage during manufacture, while being packaged and shipped to a retailer or customer, or when in service. In automotive applications, for example, an FRP body panel, engine hood, or trunk lid may be disfigured or fractured through forces generated by encounters with rough roads or severe weather during otherwise normal vehicle operation, or as a result of a collision event with another vehicle or a stationary object. These same FRP components may be fabricated with dents, cracks or other defects that result from variations in raw materials, incongruences in processing conditions, and tolerance deviations during manufacturing. Any such damaged components have to be either replaced by new parts or professionally repaired. While both of these options are costly and time consuming, part replacement concomitantly results in unwanted scrap material. Component repair—although typically less expensive with reduced part scrap—may not produce a perfectly repaired part absent perceptible structural imperfections.

### SUMMARY

Disclosed herein are repair systems and apparatuses for fixing polymer composite structures, methods for making and methods for using such repair systems, and repair techniques for fixing surface damage/defects of multidimensional thermoset or thermoplastic FRP panel structures. By way of example, and not limitation, there is presented a thermoelectric repair system for generating a wrinkle-free repair of damage to a contoured fiber-reinforced thermoplastic (FRT) composite panel. The repair system uses an integrated electrical heating sheet that is designed to generate uniform heat across the repair surface of the FRT part. Prior to heating, a repair patch or repair filler material may be placed in or across the area of repair. An elastic silicon rubber sheet with high thermal stability is placed on top of the damaged area and the immediate surrounding area of the FRT panel. A resin-impregnated carbon-fiber mat (“prepreg”) is then placed across the silicon rubber sheet. This prepreg may be cured, e.g., in situ on the FRT part during repair or offline on an undamaged part prior to repair, to form an interface that matches an undamaged part surface geometry. The heating sheet is laid across the FRT panel/rubber sheet/prepreg stackup; uniform heat is applied to melt the repair material and/or the base material in the repair region. Pressure may be applied, e.g., via vacuum bagging or other suitable procedure, to help ensure uniform contact between the FRT part surface and the rubber sheet/prepreg/heating sheet stackup. Optionally, or alternatively, a die plate that is topographically mapped to an undamaged part geometry may be pressed against the heating element to ensure uniform surface heating, e.g., for panels with recessed surface channels or other intricate geometries.

Attendant benefits for at least some of the disclosed concepts include a defect-free repaired surface, i.e., without perceptible structural or superficial imperfections, for a complex-geometry FRP composite part. Disclosed FRP composite part repair techniques help to improve part serviceability, which in turns helps to decrease plant part scrap rates, warranty costs, and labor costs. Another foreseeable advantage is the ability to repair an FRP component in situ, e.g., after installation on a vehicle or assembly on a final product, without the need for extensive disassembly. Other attendant benefits may include increased part strength, decreased part mass, lower part cost, reduced production costs, and improved fuel economy, e.g., for motor vehicle applications, when compared to conventional counterpart FRP structures.

Aspects of the present disclosure are directed to systems and attendant techniques for repairing filler/fiber-reinforced polymer structures. In an example, a thermoelectric repair system for fixing a contoured surface of an FRP structure is presented. The thermoelectric repair system includes a flexible contact sheet that is fabricated with a thermally stable polymer, and has a textured contact surface that seats on the contoured surface of the FRP structure and overlays the damaged area. A rigid cover sheet, which may be fabricated from a metal material, a polymeric material, a fibrous material impregnated with a thermally conductive resin, and/or a thermally conductive fibrous material impregnated with a resin), has a complementary surface that conforms to the contoured surface of the FRP structure and covers the flexible contact sheet. The thermoelectric repair system also includes an electric heating element that lays against the rigid cover sheet, sandwiching the flexible contact sheet and rigid cover sheet between the FRP structure and the heating element. This heating element applies a substantially uniform heating profile to the contoured surface sufficient to soften and/or melt added filler material and/or base material bordering the damaged area. In one or more alternative configurations, the functional attributes of a first one of the above-described layers may be incorporated into a second one of the layers such that the first layer may be eliminated from the system architecture.

For any of the disclosed systems, methods and devices, the thermally stable polymer of the flexible contact sheet may include a silicone rubber that exhibits negligible deterioration and negligible loss of thermal conductivity at temperatures of at least about 200-250 degrees Celsius (° C.). In addition, the thermally stable polymer may include one or more filler materials interspersed throughout the silicone rubber, e.g., to improve its thermal conductivity and mechanical integrity. This filler material may take on any suitable form, including carbon black, calcium carbonate, boron nitride, alumina, or any combination thereof. For some applications, the flexible contact sheet has a total thickness of about 1 millimeter (mm) or less, and the silicone rubber has a thermal conductivity of at least about 0.1-1.9 watts per meter-kelvin (W/(m·K)).

For any of the disclosed systems, methods and devices, the fibrous material of the rigid cover sheet includes carbon fibers, glass fibers, aramid fibers, basalt fibers, or any combination thereof. In a specific instance, the fibrous material is a carbon-fiber mat or sheet with unidirectional or multidirectional carbon fibers. The thermally conductive resin of the rigid cover sheet may include a thermoset polymer or a thermoplastic polymer; in either instance, the rigid cover sheet resin is different from the resin used in the FRP structure under repair. The rigid cover sheet material may include metals, plastics and composites; and the composite rigid cover may include a fibrous composite.

For any of the disclosed systems, methods and devices, the electric heating element includes an integrated electrical heating sheet. For at least some implementations, the heating sheet includes a pair of polymeric sheet layers with a resistance heating coil sandwiched between these polymeric layers. In a specific instance, these polymeric sheet layers each includes a silicone rubber material or a polyimide material, and the integrated electrical heating sheet has a total thickness of about 0.1 mm to 5.0 mm or, in some embodiments, 1.0 mm or less. The heating element may also be equipped with a thermal couple that is mounted to the integrated electrical heating sheet and operable to communicate with a system controller.

For any of the disclosed systems, methods and devices, the thermoelectric repair system may employ a repair material or patch that is composed of a resin polymer that nests within and/or presses against the damaged area; the repair material/patch is designed to fuse to the FRP structure in response to heat applied by the electric heating element. The thermoelectric repair system may employ a vacuum bag that covers the electric heating element, rigid cover sheet, and flexible contact sheet, and selectively applies a predetermined vacuum pressure to the contoured surface of the FRP structure. As yet another option, the repair system may employ a backing die with a forming surface that is contoured to seat against and conform to a second (underside) contoured surface of the FRP structure that is opposite the contoured surface of the FRP structure.

Additional aspects of this disclosure are directed to methods for assembling and methods for operating any of the disclosed repair systems. In an example, a method is presented for repairing a damaged area of a contoured surface of a fiber-reinforced polymer structure. This representative method includes, in any order and in any combination with any of the above or below disclosed features and options: placing a flexible contact sheet on the FRP structure such that a textured contact surface of the flexible contact sheet seats against the contoured surface and overlays the damaged area of the FRP structure, the flexible contact sheet including a thermally stable polymer; placing a rigid cover sheet on the FRP structure such that a complementary contoured surface of the rigid cover sheet conforms to the FRP structure's contoured surface and covers the flexible contact sheet, the rigid cover sheet including a fibrous material impregnated with a thermally conductive resin; placing an electric heating element against the rigid cover sheet; and applying, via the electric heating element to the FRP structure through the rigid cover sheet and flexible contact sheet, a substantially uniform heating profile. The applied heat is sufficient to soften and/or melt at least a bordering area of the FRP structure's contoured surface neighboring the damaged area.

The above summary is not intended to represent every embodiment or every aspect of the present disclosure. Rather, the foregoing summary merely provides an exemplification of some of the novel concepts and features set forth herein. The above features and advantages, and other features and attendant advantages of this disclosure, will be readily apparent from the following detailed description of illustrated examples and representative modes for carrying out the present disclosure when taken in connection with the accompanying drawings and the appended claims. Moreover, this disclosure expressly includes any and all combinations and subcombinations of the elements and features presented above and below.

### BRIEF DESCRIPTION OF THE DRAWINGS

FIG. 1 is an exploded perspective-view illustration of a representative repair system for fixing a damaged area of a multidimensional polymer composite structure in accordance with aspects of the present disclosure.

FIG. 2 is a schematic illustration of another representative repair system for repairing a multidimensional fiber-reinforced polymer structure in accordance with aspects of the present disclosure.

The present disclosure is amenable to various modifications and alternative forms, and some representative embodiments have been shown by way of example in the drawings and will be described in detail herein. It should be understood, however, that the novel aspects of this disclosure are not limited to the particular forms illustrated in the above-enumerated drawing. Rather, the disclosure is to cover all modifications, equivalents, combinations, subcombinations, permutations, groupings, and alternatives falling within the scope of this disclosure as encompassed by the appended claims.

### DETAILED DESCRIPTION

This disclosure is susceptible of embodiment in many different forms. There are shown in the drawings and will herein be described in detail representative embodiments of the disclosure with the understanding that these illustrated examples are provided as an exemplification of the disclosed principles, not limitations of the broad aspects of the disclosure. To that extent, elements and limitations that are described, for example, in the Abstract, Introduction, Summary, and Detailed Description sections, but not explicitly set forth in the claims, should not be incorporated into the claims, singly or collectively, by implication, inference or otherwise. For purposes of the present detailed description, unless specifically disclaimed: the singular includes the plural and vice versa; the words “and” and “or” shall be both conjunctive and disjunctive; the words “any” and “all” shall both mean “any and all”; and the words “including” and “comprising” and “having” shall each mean “including without limitation.” Moreover, words of approximation, such as “about,” “almost,” “substantially,” “approximately,” and the like, may be used herein in the sense of “at, near, or nearly at,” or “within 0-5% of,” or “within acceptable manufacturing tolerances,” or any logical combination thereof, for example.

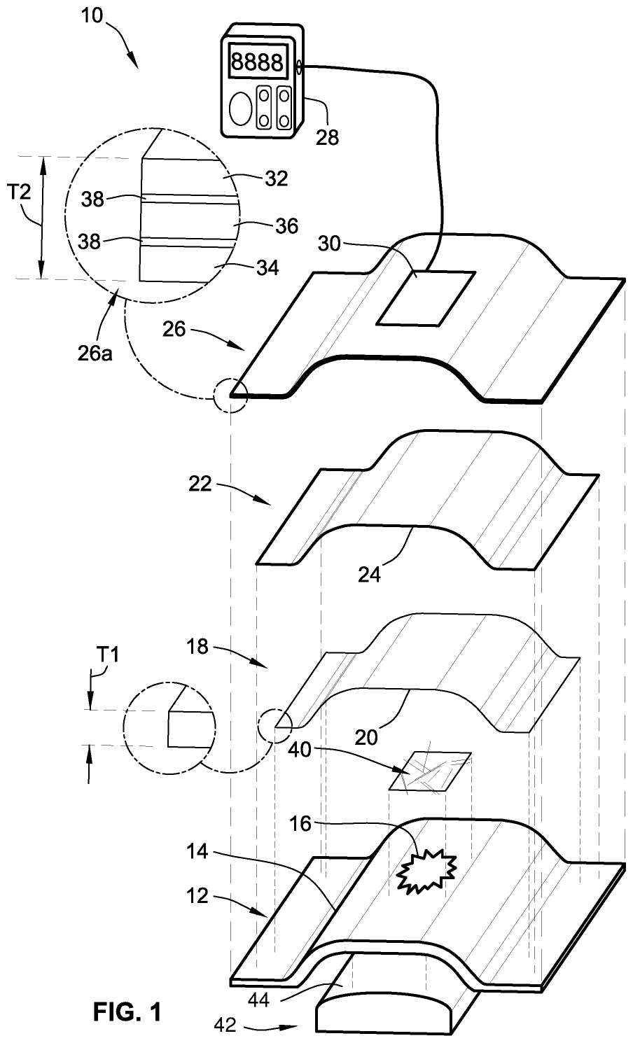

Referring now to the drawings, wherein like reference numbers refer to like features throughout the several views, there is shown in FIG. 1 a representative thermoelectric repair system, designated generally at 10, for repairing a composite polymer construction, such as a multidimensional fiber-reinforced plastic (FRP) structure 12. The illustrated thermoelectric repair system 10—also referred to herein as “repair system” for brevity—is merely an exemplary application with which novel aspects and features of this disclosure may be practiced. In the same vein, implementation of the present concepts for repairing an FRP panel 12 of a motor vehicle should also be appreciated as a representative application of the novel aspects and features disclosed herein. As such, it will be understood that aspects and features of this disclosure may be implemented for repairing other polymer composite constructions, including automotive and non-automotive applications alike, and may be integrated into any logically relevant type of repair system architecture. Moreover, only select components of the thermoelectric repair system 10 have been shown by way of example in the drawings and will be described in detail herein. Nevertheless, the repair system 10 of FIG. 1 may include numerous additional and alternative features, as well as other available and hereinafter developed peripheral components, without departing from the intended scope of this disclosure. Lastly, the features presented in FIG. 1 are not necessarily to scale and are provided purely for instructional purposes. Thus, the specific and relative dimensions shown in the FIG. 1 are not to be construed as limiting.

FIG. 1 depicts a portion of an exemplary composite polymer structure, namely a chopped-fiber-reinforced thermoplastic (CFRT) vehicle panel 12, that is illustrated with an omega-shaped exterior surface 14. At the crest of this contoured surface 14 there is a defective or damaged area 16, which is represented in the drawings as a jagged puncture extending through the vehicle panel 12 (also designated herein as “FRP structure”). As used herein, the terms “damage” and “defect,” including permutations thereof, may be used interchangeably and synonymously to denote any visibly perceptible deformity, aperture, abrasion, or other structural flaw in a composite polymer structure. While portrayed as a fiber-reinforced thermoplastic, the composite polymer structure may take on other similarly applicable forms, including thermosetting polymers (or “thermosets”) and composite polymer structures using filler materials in addition to, or in lieu of, fiber reinforcement. An advantage to utilizing thermoplastics over thermosets is that a thermoplastic structure, once formed, may be heated to a corresponding melting point to soften or melt the polymer, and then reshaped through applications of pressure. Provided the heating temperature is tightly regulated and limited to modestly exceeding the polymer softening point, such reshaping may be performed without appreciably degrading the properties of the structure under repair.

Thermoelectric repair system 10 is designed to fix and restore the damaged area 16 to a substantially defect-free complex-geometry surface (i.e., one without perceptible structural or superficial imperfections). Seated on top of the contoured surface 14 is a flexible contact sheet 18 that overlays and, in some implementations, directly contacts the damaged area 16 of the FRP structure 12. This flexible contact sheet 18 is fabricated from an elastic, thermally stable polymer. For at least some implementations, the thermally stable polymer of the flexible contact sheet 18 includes (or consist essentially of) a silicone rubber that may exhibit superior thermal stability, high thermal conductivity, tactile compressibility and, if so desired, general resistance to chemicals, oils, debris and dirt. For example, it may be desirable that the silicone rubber exhibit negligible mass deterioration and negligible loss of thermal conductivity at temperatures of at least about 200° C. or, for some applications, at temperatures of at least 250° C. In addition, the silicone rubber may exhibit a thermal conductivity of at least about 0.1 to 1.9 watts per meter-kelvin (W/(m·K)).

Thermal stability and conductivity, as well as tear and tensile strengths of the flexible contact sheet 18, may be selectively modified by adding one or more filler materials to the silicone rubber matrix. By way of non-limiting example, the filler material may comprise, in any combination, carbon black, calcium carbonate, boron nitride, silica, clay, graphite, alumina and/or other filler suitable for the intended application. In a specific example, mixed-particle-size boron nitride powder interspersed in a controlled weight ratio improves thermal conductivity and coefficient of thermal expansion for silicone rubber composites. For at least some embodiments, the flexible contact sheet 18 has a total thickness T1 of about 0.1-1.5 millimeters (mm) or less, which may be substantially uniform over the length and width thereof. Desired stretchability and compressibility may be achieved with a polymer Shore A durometer hardness of about 80 or less or, in at least some embodiments, about 20-40 Shore A.

With continuing reference to FIG. 1, the flexible contact sheet 18 has an underside contact surface 20 that is similarly contoured to sit generally flush against and conform to the contoured surface 14 of the FRP structure 12. This contact surface 20 may be texturized to mimic the FRP structure's contoured surface 14 had there been no damaged area 16. As used herein, the term “textured,” including permutations thereof, may refer to a surface with a grainy, roughed, or otherwise non-smooth finish. In accord with the illustrated application, the FRP structure 12 has a natural surface texture—or “grain”—that results from the materials and techniques used to fabricate fiber-reinforced plastic constructions (e.g., resin transfer molding (RTM), compression molding, etc.). Flexible contact sheet 18 may be formed by applying and curing a Room-Temperature-Vulcanizing (RTV) silicone rubber paste on a non-damaged vehicle panel or, alternatively, on a flat metal or rigid-plastic plate that is machined with a surface texture that is comparable to a non-damaged vehicle panel. In so doing, the flexible contact sheet's contact surface 20 will take on a surface texture that simulates a non-damaged part's tactility and appearance; during repair, this texture will imprint on the contoured surface 14 of the FRP structure 12. Concomitantly, the flexible contact sheet 18 prevents the surface texture of the rigid cover sheet 22 or that of the electric heating element 26 from inadvertently imprinting onto the FRP structure 12 during repair. The underside contact surface 20 of the contact sheet 18 may be coated (i.e. sputter coating, chemical vapor deposition (CVD), etc.) to form a conductive resistance heating layer.

To prevent deformation of the contoured panel when it is heated to softening during the repair process, to prevent the surface texture of the heating element from being imprinted onto the panel surface, and to facilitate uniform surface heating with improved in-plane thermal conductivity that will help to preclude formation of localized hot or cold spots, the thermoelectric repair system 10 employs a rigid cover sheet 22 that is placed over the damaged area 16, seated against the FRP structure's contoured surface 14. With this arrangement, the flexible contact sheet 18 is sandwiched between the rigid cover sheet 22 and FRP structure 12. According to the representative architecture of FIG. 1, this rigid cover sheet 22 is fabricated from a thermally conductive fibrous material that is pre-impregnated with a resin or a fibrous material that is pre-impregnated with a thermally conductive resin, thus forming what is known as a “prepreg” composite. For instance, the fibrous material may be a composition of carbon fibers, glass fibers, aramid fibers, basalt fibers, and/or any other suitable reinforcing fiber, which may be arranged unidirectionally, bidirectionally, or multi-directionally. The fiber composition may be woven or compacted, and subsequently cut into a generally flat mat or roving. This fiber rove or mat is steeped in, sprayed, or otherwise infused with a thermoset or thermoplastic resin matrix. Irrespective of whether thermosets or thermoplastics are used, the resin of the rigid cover sheet 22 is different from the primary resin used to manufacture the FRP structure 12. According to the illustrated example, the rigid cover sheet 22 may be a thermoset-resin impregnated, graphite carbon fiber mat with a high thermal conductivity, e.g., of about 0.4 to 800 W/(m·K) or, in some embodiments, about 4.0-6.0 W/(m·K).

Rigid cover sheet 22 is fabricated with a complementary (lower) surface 24 that is shaped and sized to conform to the contoured exterior surface 14 of the FRP structure 12; when properly positioned, the cover sheet 22 of FIG. 1 covers and conceals the entire flexible contact sheet 18. To achieve a substantially flush fit between these neighboring parts, the cover sheet 22 prepreg may be applied to the corresponding section of a non-damaged counterpart of the vehicle panel 12, and thereafter fully cured to maintain desired part geometry. Curing may be accomplished by any suitable means, including ultraviolet (UV) or electron beam irradiation, exothermic control, heat, chemical additives, and the like. Conversely, if the damaged area 16 is generally limited to superficial defects (e.g., scratches, slight warping, shear bands, crazing, etc.), cover sheet 22 prepreg may be applied directly to the FRP structure 12 and cured in situ. For at least some applications, the rigid cover sheet 22, once cured, should be sufficiently stiff to withstand applied pressures of at least 5 kilopascals (kPa) or, in some embodiments, at least 100 kPa without fracturing. Conversely, rigid cover sheet 22 should maintain some elasticity to allow for ease of application and part-to-part variations. In addition to facilitating uniform surface heating with controlled in-plane thermal conductivity, the rigid cover sheet 22 may also help to prevent surface variations on the underside surface of the electric heating element 26 from imprinting onto the repaired part surface 14.

Draped across the rigid cover sheet 22 of FIG. 1 is an electric heating element 26 that enshrouds the stacked contact and cover sheets 18, 22 and, if desired, abuts that portion of the contoured surface 14 immediately outside the periphery of the cover sheet 22. Once properly situated, the heating element 26 may be selectively activated, e.g., via system controller 28, to apply heat with a substantially uniform heating profile to the contoured surface 14 of FRP structure 12. This applied heat is sufficient to at least soften, if not completely melt, the section of the FRP structure 12 that neighbors and generally circumscribes the damaged area 16. A thermal couple 30, which is shown mounted to the top of the electric heating element 26, communicates (wired or wirelessly) with the system controller 28, e.g., to provide closed-loop feedback for modulating system operation. Uniform heating of the part surface 14—via heating element 26 through rigid cover sheet 22 and then through flexible contact sheet 18—functions to soften and/or melt any base material immediately adjacent the damaged area 16 as well as optional repair material 40 that covers or fills the damaged area 16 to recover the FRP structure 12 and any attendant surface grain. Heating temperatures may need to be tightly controlled via system controller 28, as overheating the FRP structure 12 may permanently damage the base material, and under-heating the FRP structure 12 may leave the surface 14 unrepaired.

The thermoelectric repair system 12 may employ a variety of different heating devices; the electric heating element 26 of FIG. 1, for example, is illustrated as an integrated electrical heating sheet 26A. Specifically, as shown in the inset view of FIG. 1, the integrated electrical heating sheet 26A is fabricated with a pair of (outer) polymeric sheet layers 32 and 34, respectively, that sandwich therebetween a resistance heating coil 36. Optional adhesive layers 38 are disposed on opposing sides of the resistance heating coil 36, joining the polymeric sheet layers 32, 34 to the heating coil 36. Each of these polymeric sheet layers 32, 34 may be fabricated from a silicone rubber material or a polyimide material with high thermal conductivity and stability. Once assembled, the integrated electrical heating sheet 26A has a generally uniform, total thickness T2 of about 0.5 mm to 5.0 mm or, in some embodiments, about 1.0 mm or less. Surface treatments may be applied to one or both outer sheet layers 32, 34 to increase tackiness and contact surface area.

For applications in which damage has resulted in a loss of or a gap in material, such as where the part suffers a puncture, deep gouge, or sizeable cavity, repair material may be introduced to the damage zone prior to initiating the repair process. In accord with the representative arrangement presented in FIG. 1, an optional repair material or patch 40 may be placed into or directly on top of the jagged puncture in damaged area 16. This repair material/patch 40 may be composed of a resin polymer—with or without filler material or fiber reinforcement—that fills the damaged area 16 and fuses to the FRP structure 12 as a result of the heat applied by the electric heating element 26. For the fiber-reinforced thermoplastic repair of FIG. 1, the repair material/patch 40 may consist essentially of a pure nylon film or, for larger holes or fissures, a mixture of nylon resin granules and chopped carbon fibers blended with carbon black. Alternatively, for a repair of a thermoset composite structure, the repair material/patch 40 may comprise a viscous epoxy monomer that is spread on the damaged area 16 and adjoining surfaces. It may be desirable that the polymer composition, fiber characteristics, and filler content of the repair material 40 substantially match that of the component being repaired. Optionally, the repair material 40 may substitute alternative fillers or fibers or incorporate fillers and fibers in differing concentrations. The repair material/patch 40 may be unconsolidated, e.g., in the form of pellets, granules or similarly convenient form, or may be consolidated, e.g., into a viscous liquid or generally planar patch. A backing die 42 with a complementary shaped arcuate top surface 44 may be pressed against the underside of the FRP structure 12 to prevent the repair material 40 from falling through the puncture and to maintain the part's shape during repair. In one or more alternative configurations, the functional attributes of a first one of the above-described layers may be incorporated into a second one of the layers such that the first layer may be eliminated from the system architecture.

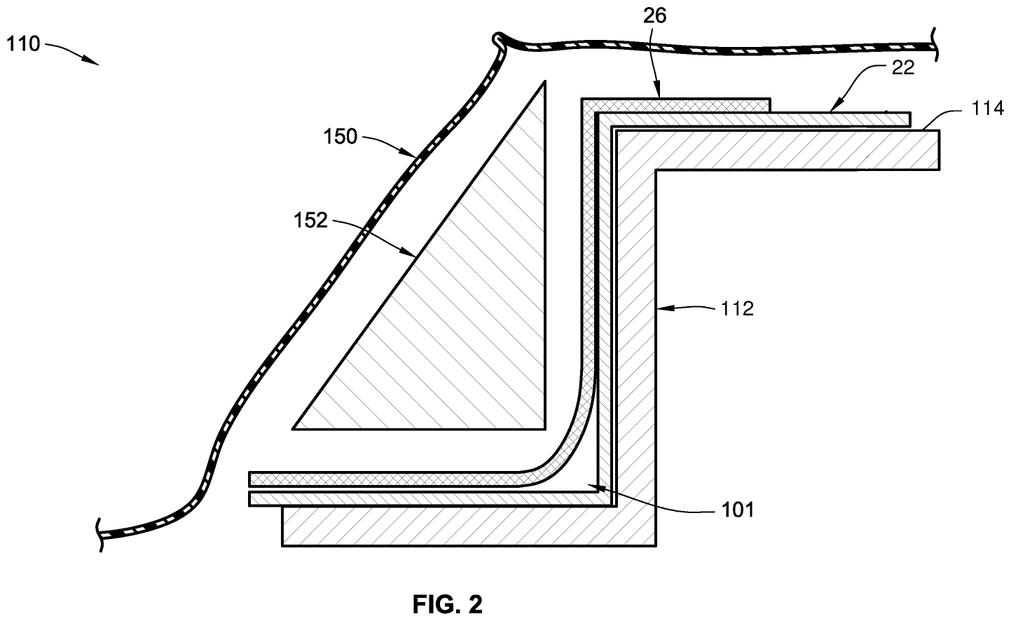

Turning next to FIG. 2, there is shown another representative thermoelectric repair system 110 for fixing a damaged or defective composite polymer construction, such as corrugated carbon-fiber reinforced thermoplastic panel structure 112. Although differing in appearance, the repair system 110 of FIG. 2 may include any of the features, options, and alternatives described above with respect to the repair system 10 of FIG. 1, and vice versa. For instance, repair system 110 of FIG. 2 may utilize the flexible contact sheet 18, rigid cover sheet 22, electric heating element 26 and/or repair material 40 of FIG. 1 during the repair of panel structure 112. In the same vein, repair system 10 of FIG. 1 may employ the vacuum bag 150 and/or top die plate 152 of FIG. 2 during the repair of FRP panel 12. With the multidimensional geometry and textured surface of the polymer composite structures 12, 112, tolerance variances and friction between interfacing surfaces of the FRP structure 12, 112 and contacting components of the repair system 10, 110 may cause bridging and interposing gaps. Vacuum bag 150 may be applied over and, optionally, attached to the exterior contoured surface 114 of the FRP structure 112 to create a sealed enclosure that covers the repair region and any repair components stacked thereon. A vacuum source, such as an electric-motor-driven rotodynamic or positive displacement pump (not shown), is fluidly coupled to the vacuum bag 150 to evacuate air from the sealed enclosed; this creates a vacuum pressure on the stackup of repair parts to minimize unwanted bridging and any resultant gaps.

Many polymer composite parts, such as cargo bed panels for pickup trucks and industrial vehicles, are formed with elongated channels and other recessed structural features. These recessed features my cause bridging and gaps between the heating element 26 and the contoured surface 114, an example of which is designated generally at 101 in FIG. 2. The repair system 110 employs top die plate 152 (also referred to as “corner guide”) to press the rigid cover sheet 22 and, thus, the heating element 26 against the FRP structure's contoured surface 114, e.g., to ensure there is flush contact between the panel surface and the heating element/rigid cover sheet/surface textured layer stackup. Interfacing portions of the top die plate 152 and rigid cover sheet 22 may be topographically mapped to the corrugated and recessed segments of the contoured surface 114 being repaired. The top die plate 152 is a thermal insulator fabricated from a material with low thermal conductivity and low thermal mass, such as an epoxy resin thermoset, wood, high density polyurethane foam, machined nylon or a combination thereof. An (upper) forming surface of the cover sheet 22 may be contoured to seat against, conform to and buttress the topside contoured surface 114 of the FRP structure 112. Good contact between a cover sheet and a panel surface helps to ensure uniform surface heating. The top die plate 152 pushes the heating element against the cover sheet to reduce the gap 101 between the heating element and cover sheet to further improve the repair quality. Top die plate 152 can also push the thermally conductive cover sheet 114 against the panel surface.

To complete a repair of a damaged/defective contoured surface of a polymer composite structure, such as the FRP structure 12 of FIG. 1 or FRP structure 112 of FIG. 2, the part is heated to approximately 220-250° C. with an applied vacuum pressure of approximately 0.5-1.0 standard atmospheric pressure (atm). A non-critical ramp-up time of approximately 5-7 mins allows the repair system 110 to reach a minimum 220° C. and 0.5 atm. The FRP structure is heated for about 4-7 minutes, and then allowed to cool and cure for approximately 10 minutes or more. Prior to repair, the contoured surface 114 is cleaned to remove errant dirt, abraded material and debris; for some applications, there is no need for post surface treatment of the repaired part. The parameters described above are merely representative of one potential application of the repair systems and techniques presented herein, and are therefore non-limiting in nature.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. A repair system for fixing a damaged area of a contoured surface of a fiber-reinforced polymer (FRP) structure, the repair system comprising:
a flexible contact sheet including a thermally stable polymer and having a textured contact surface configured to seat on the FRP structure and overlay the damaged area;
a rigid cover sheet having a complementary surface configured to conform to the contoured surface of the FRP structure and cover the flexible contact sheet; and
a heating element configured to lay against the rigid cover sheet and apply a substantially uniform heating profile to the contoured surface sufficient to soften and/or melt at least a bordering area of the FRP structure neighboring the damaged area.

2. The repair system of claim 1, wherein the thermally stable polymer of the flexible contact sheet includes a silicone rubber exhibiting negligible deterioration and loss of thermal conductivity at temperatures of at least about 200 degrees Celsius (° C.).

3. The repair system of claim 2, wherein the thermally stable polymer includes a filler material interspersed throughout the silicone rubber.

4. The repair system of claim 3, wherein the filler material includes carbon black, calcium carbonate, boron nitride, and/or alumina.

5. The repair system of claim 2, wherein the flexible contact sheet has a total thickness of about 1 millimeter (mm) or less.

6. The repair system of claim 2, wherein the silicone rubber has a thermal conductivity of at least about 1.0 watts per meter-kelvin (W/(m·K).

7. The repair system of claim 1, wherein the rigid cover sheet includes a fibrous material impregnated with a resin, and wherein the fibrous material includes carbon fibers, glass fibers, aramid fibers, basalt fibers, or any combination thereof.

8. The repair system of claim 7, wherein the fibrous material is a carbon-fiber mat or a roving of unidirectional carbon fibers.

9. The repair system of claim 7, wherein the FRP structure includes a thermoplastic resin, and wherein the resin of the rigid cover sheet includes a thermoset polymer or a thermoplastic polymer and is different from the thermoplastic resin of the FRP structure.

10. The repair system of claim 1, wherein the heating element includes an integrated electrical heating sheet.

11. The repair system of claim 10, wherein the integrated electrical heating sheet includes inner and outer polymeric layers and a resistance heating coil sandwiched between the inner and outer polymeric layers.

12. The repair system of claim 11, wherein each of the inner and outer polymeric layers includes a silicone rubber material or a polyimide material, the integrated electrical heating sheet having a total thickness of about 1.0 mm to 5.0 mm.

13. The repair system of claim 11, wherein the heating element further includes a thermal couple operatively attached to the integrated electrical heating sheet and configured to communicate with a system controller.

14. The repair system of claim 1, further comprising a repair material or patch including a resin polymer configured to nest within and/or press against the damaged area and fuse to the FRP structure in response to heat applied by the heating element.

15. The repair system of claim 1, further comprising a vacuum bag configured to cover the heating element, rigid cover sheet, and flexible contact sheet and apply a vacuum pressure to the contoured surface of the FRP structure.

16. The repair system of claim 1, further comprising a backing die having a forming surface configured to seat against and conform to a second contoured surface of the FRP structure opposite the contoured surface of the FRP structure.

17. A method of repairing a damaged area of a contoured surface of a fiber-reinforced polymer (FRP) structure, the method comprising:
placing a flexible contact sheet on the FRP structure such that a textured contact surface of the flexible contact sheet seats against the contoured surface and overlays the damaged area, the flexible contact sheet including a thermally stable polymer;
placing a rigid cover sheet on the FRP structure such that a complementary surface of the rigid cover sheet conforms to the contoured surface and covers the flexible contact sheet;
placing a heating element against the rigid cover sheet; and
applying, via the heating element, a substantially uniform heating profile to the FRP structure sufficient to soften and/or melt at least a bordering area of the contoured surface neighboring the damaged area.

18. The method of claim 17, wherein the thermally stable polymer of the flexible contact sheet includes a silicone rubber exhibiting negligible deterioration and loss of thermal conductivity at temperatures of at least about 200 degrees Celsius (° C.), the flexible contact sheet having a total thickness of about 1 millimeter (mm) or less.

19. The method of claim 17, wherein the rigid cover sheet includes a fibrous material impregnated with a resin, the fibrous material including carbon fibers, glass fibers, aramid fibers, basalt fibers, or any combination thereof, and wherein the resin of the rigid cover sheet includes a thermoset polymer or a thermoplastic polymer that is different from a resin of the FRP structure.

20. The method of claim 17, wherein the heating element includes an integrated electrical heating sheet with inner and outer polymeric layers and a resistance heating coil sandwiched between the inner and outer polymeric layers.
